(19) United States
(12) Patent Application Publication
(10) Pub. No.: US 2020/0323366 A1
(43) Pub. Date: Oct. 15, 2020

(54) APPARATUS AND METHOD FOR FLORAL ARRANGEMENT

(71) Applicants: Han Luk, Hong Kong (HK); Edmond K. Chow, Hong Kong (HK)

(72) Inventors: Han Luk, Hong Kong (HK); Edmond K. Chow, Hong Kong (HK)

(21) Appl. No.: 16/389,952

(22) Filed: Apr. 21, 2019

Related U.S. Application Data
(63) Continuation-in-part of application No. 29/687,643, filed on Apr. 15, 2019.

(51) Int. Cl. A47G 7/07; B65D 25/10; A01G 5/00

(52) U.S. Cl. CPC A47G 7/07; A01G 5/00; B65D 25/108

(57) ABSTRACT

An invention is disclosed for processes, apparatuses, articles, structures, and supports in relation to floral arrangements. Embodiments of such a process, apparatus, article, structure and support would provide, among other benefits and advantages, a more cost-effective and versatile support for placing or supporting one or more floral pieces in a container. For instance, one embodiment comprises the following: a first section, wherein the first section comprises one or more sides and one or more widths, the one or more widths fit within a neck of the container by having the one or more sides in contact with one or more sections of an inner surface of the neck, the container comprises a mouth leading to the one or more sections of the inner surface of the neck; a second section, wherein the second section comprises one or more floral pieces, and at least one floral piece from among the one or more floral pieces extends above the opening of the mouth when the one or more sides associated with the first section are in contact with the one or more sections of the inner surface; and a third section, wherein the third section comprises one or more stem pieces, and at least one stem piece from among the one or more stem pieces extends below the neck when the one or more sides associated with the first section are in contact with the one or more sections of the inner surface.

### CROSS-REFERENCES TO RELATED APPLICATIONS

The present application is a continuation-in-part of U.S. application Ser. No. 29/687,643, filed Apr. 15, 2019 and entitled “Article for Floral Arrangements.”

### TECHNICAL FIELD

The present invention relates to processes, apparatuses, articles, structures, and supports for floral arrangements. In particular, embodiments of the present invention provide improved processes, apparatuses, articles, structures, and supports for flower arrangements that involve placement of one or more floral pieces, artifacts, items or objects in a container or other types of receptacle, among other benefits and advantages.

### BACKGROUND

It could be challenging to hold a flower or a floral arrangement in an upright position or keep its pre-arranged presentation in a container, such as when the width or thickness of the stem(s) of the flower or floral arrangement is narrow compared to the width or diameter of the container's mouth, or when the floral arrangement is in form of a bouquet whose intended orientation for presentation cannot be supported by the rim or mouth of the container. On the other hand, when the rim or mouth of the container is relied upon as support for the floral arrangement, it could become a constraint that limits the applicability of such arrangement to similar containers. In addition, manufacturers of artificial flowers may use artificial water, such as one made from resins, in transparent or translucent vase floral arrangements. Artificial water could provide some support once it is cured or set in. However, using artificial water adds cost to production and transport. Furthermore, artificial water can shrink, crack, or discolor over time.

### SUMMARY

In accordance with one aspect of the present invention or one of its embodiments, there is provided a method for providing floral arrangement involving a container, where the method comprises preparing an object of a certain specification, affixing one or more floral pieces to the object, and inserting the object into the container. For instance, such an object may comprise an opening and one or more sides, and dimensions that fit the object within a neck of the container by having the one or more sides in contact with one or more sections of an inner surface of the neck. The container may comprise a mouth leading to the one or more sections of the inner surface of the neck, where cross-section planes from the mouth to the one or more sections may comprise perimeters large enough for the object, with a face of the opening facing the mouth, to arrive at the one or more sections via the mouth, and where one or more cross-section planes beyond the one or more sections may comprise perimeters small enough for preventing the object from arriving beyond the one or more sections.

In one embodiment, the one or more floral pieces may comprise at least one flower and at least one stem, where the at least one flower extends from the face of the opening associated with the object, the at least one stem extends from another face of the opening associated with the object, and the one or more floral pieces pass through at least partially the opening across the face and the other face. In one embodiment, the object is inserted into the container with the at least one stem towards the neck via the mouth, until the one or more sides associated with the object come into contact with the one or more sections of the inner surface of the neck, at least one part of the at least one flower being exposed above the mouth and at least one part of the at least one stem being placed below the neck.

In accordance with another aspect of the present invention or one of its embodiments, there is provided an article for providing floral arrangement involving a container or otherwise being placed in a container, where the article comprises three sections. For instance, a first section may comprise one or more sides and one or more widths, where the one or more widths may fit within a neck of the container by having the one or more sides in contact with one or more sections of an inner surface of the neck, and the container may comprise a mouth leading to the one or more sections of the inner surface of the neck. A second section may comprise one or more floral pieces, where at least one floral piece from among the one or more floral pieces may extend above the opening of the mouth when the one or more sides associated with the first section are in contact with the one or more sections of the inner surface. A third section may comprise one or more stem pieces, where at least one stem piece from among the one or more stem pieces may extend below the neck when the one or more sides associated with the first section are in contact with the one or more sections of the inner surface.

In accordance with yet another aspect of the present invention or one of its embodiments, there is provided an apparatus for providing floral arrangement, where the apparatus comprises a container, one or more floral pieces, and an object of a certain specification. For instance, such an object may comprise a receptacle and one or more sides, where the object fits within an inner perimeter of a neck of the container through contact between the one or more sides of the object and one or more sections of the inner perimeter of the neck, and at least one lengthwise section associated with the one or more floral pieces fits into the receptacle. In one embodiment, the one or more floral pieces may comprise at least one flower and at least one stem, and the at least one flower extends away from the receptacle towards the top of the container, and the at least one stem extends away from the receptacle towards the bottom of the container.

### Objects and Advantages

Among other benefits and advantages, embodiments of the present invention provide reliable and convenient methods, apparatuses, articles and means for placement of flowers or floral arrangements in a container. These and other aspects of the present invention provide significant benefits and advantages over prior art, such as the art of manufacturing of vase flowers with cured artificial water. Further objects and advantages of the present invention will become apparent from consideration of the description or disclosure herein.

### BRIEF DESCRIPTION OF THE DRAWINGS

FIG. 1 illustrates a top view of a design in accordance with an embodiment of the present invention.

FIG. 2 illustrates a side view of a design in accordance with an embodiment of the present invention.

FIG. 3 illustrates a bottom view of a design in accordance with an embodiment of the present invention.

FIG. 4 illustrates a sectional view of a design in accordance with an embodiment of the present invention.

FIG. 5 illustrates a side view of a design with flowers shown, in accordance with an aspect or embodiment of the present invention.

FIG. 6 illustrates a cross section view of a design with flowers shown, in accordance with an aspect or embodiment of the present invention.

FIG. 7 illustrates another cross section view of a design with flowers shown, in accordance with an aspect or embodiment of the present invention.

FIG. 8 illustrates a composite view of a design with flowers and container shown, in accordance with an aspect or embodiment of the present invention.

FIG. 9 illustrates another cross section view of a design with flowers and container shown, in accordance with an aspect or embodiment of the present invention.

FIG. 10 illustrates an exemplary method or process 1000 for providing floral arrangement involving a container in accordance with an aspect or embodiment of the present invention.

FIG. 11 illustrates a top view and a side view of a design in accordance with an aspect or an embodiment of the present invention.

FIG. 12 illustrates another top view and another side view of a design in accordance with an aspect or an embodiment of the present invention.

FIG. 13 illustrates top views of two designs in accordance with an aspect or an embodiment of the present invention.

FIG. 14 illustrates top views of two other designs in accordance with an aspect or an embodiment of the present invention.

FIG. 15 illustrates top views of yet two other designs in accordance with an aspect or an embodiment of the present invention.

FIG. 16 illustrates a set of two top views and one side view in accordance with an aspect or an embodiment of the present invention.

FIG. 17 illustrates another set of two top views and one side view in accordance with an aspect or an embodiment of the present invention.

FIG. 18 illustrates at least one cross section view of an object or article in accordance with an aspect or an embodiment of the present invention.

FIG. 19 illustrates at least one cross section view of an object or article along with flowers, in accordance with an aspect or an embodiment of the present invention.

FIG. 20 illustrates another cross section view of an object or article along with flowers being placed in a container, in accordance with an aspect or an embodiment of the present invention.

FIG. 21 illustrates a cross section view and a top view of a tool in accordance with an aspect or an embodiment of the present invention.

FIG. 22 illustrates an example way of coupling without the need of adhesive material in accordance with an aspect or an embodiment of the present invention.

FIG. 23 illustrates a cross section view of a coupling in accordance with an aspect or an embodiment of the present invention.

FIG. 24 illustrates two side views and a cross section view in accordance with an aspect or an embodiment of the present invention.

FIG. 25 illustrates two side views, each comprising an object or article in a container, in accordance with an aspect or an embodiment of the present invention.

FIG. 26 illustrates side views of two objects or articles in a container, in accordance with an aspect or an embodiment of the present invention.

### DETAILED DESCRIPTION OF ILLUSTRATIVE EMBODIMENTS

Disclosed are processes, apparatuses, articles, structures and supports for floral arrangements in accordance with the present invention.

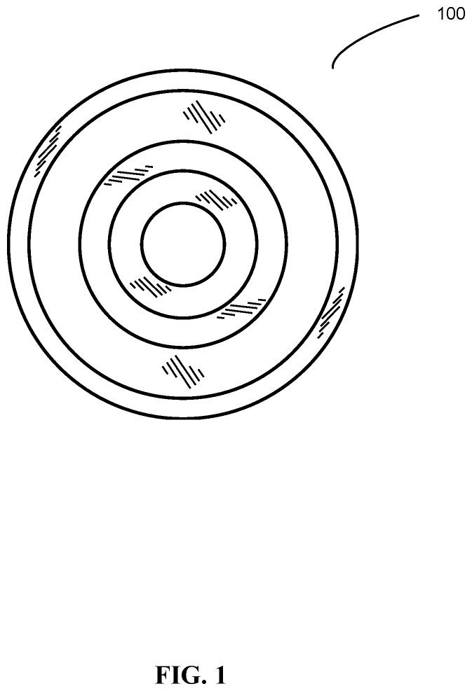

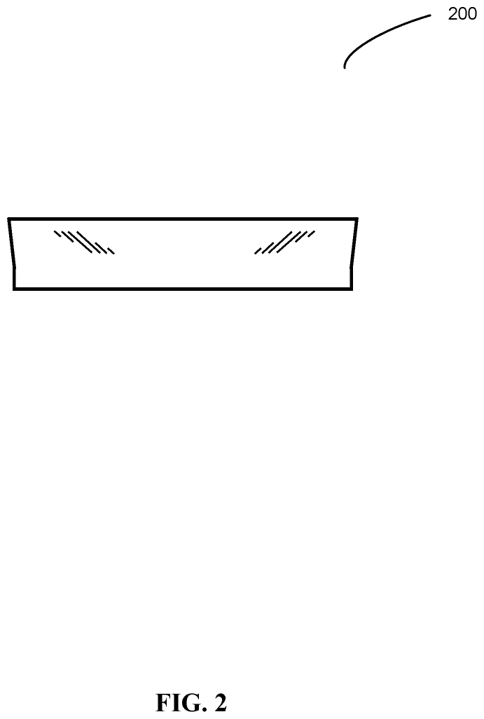

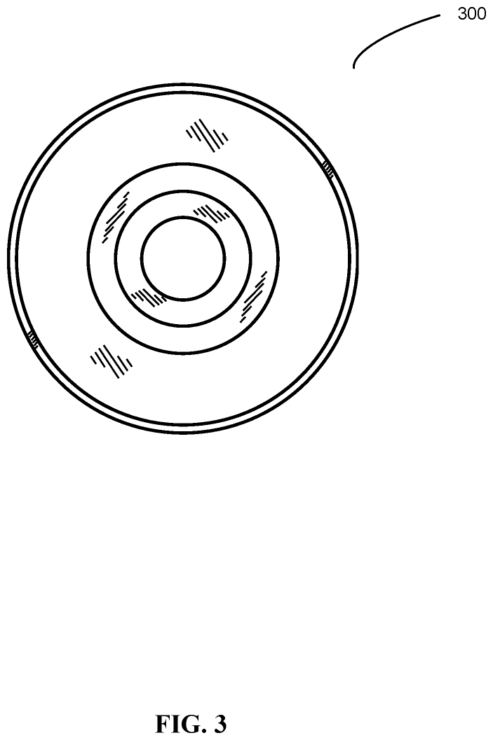

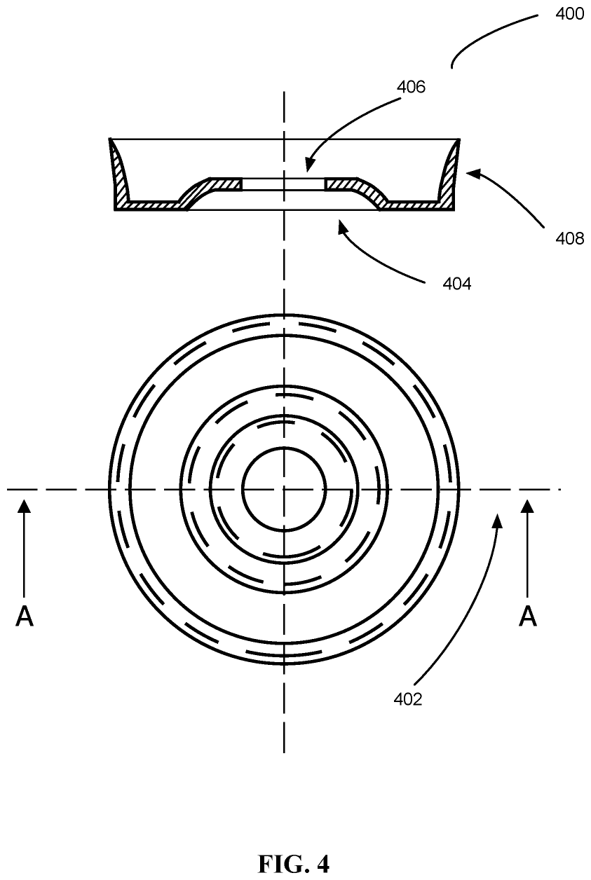

FIGS. herein or herewith illustrate a plenty of design and functional aspects and features in accordance with various embodiments of the present invention. For instance, FIG. 1 to FIG. 3 illustrate respectively a top view 100, a side view 200, and a bottom view 300 of a design for an object or article that may be used for supporting or being a part of a floral arrangement in a container, in accordance with an aspect or embodiment of the present invention. FIG. 4 illustrates a sectional view of such a design with respect to the cutting-plane line A-A 402. As shown in FIG. 4, an object or article having a top view, a side view, a bottom view, and a sectional view corresponding to the top view 100, the side view 200, the bottom view 300, and the sectional view 400, would comprise a dome-shaped hallow space or a recess 404 that has a circular opening 406 at its top, through which one or more floral pieces can be inserted or placed, or at which the one or more floral pieces may be held.

In one embodiment, one or more stem-comprising floral pieces are bound through the opening 406. In another embodiment, a bouquet of artificial flowers is coupled to the object or article through the opening 406 with adhesive material. For example, the recess 404 may provide the space for applying such adhesive material, while hiding the material from horizontal or level view when the object or article is placed upright inside a vertically oriented neck of a container. Adhesive material could also be applied on the surface above, and/or around the inner wall or side of, the opening 406.

In one embodiment, the shape of the exterior side 408 of the object or article is curved inwards, as shown in FIG. 4. For example, such a curved exterior side may correspond to or approximate the curvature of one or more sections of an inner surface of a section of the neck of a container, such that the object or article may be situated or otherwise placed securely or statically at or near the inner surface of the neck.

In one embodiment, the object or article may comprise or be made of semi-rigid material, such as semi-rigid synthetic-polymer, semi-rigid plastic plug, or semi-rigid nylon tube fitting, or any combination thereof. In another embodiment, the object or article may comprise or be made of plastic, glass, crystal, or metal, or any combination thereof. In one embodiment, the object or article may comprise or be made of transparent or translucent material. In one embodiment, the object or article may comprise or be made of colored material. In one embodiment, the object or article may comprise or be made of polycarbonate (PC), acrylic, polyethylene terephthalate (PET), amorphous copolyester (PETG), polyvinyl chloride (PVC), liquid silicone rubber (LSR), cyclic olefin copolymers (COC), polyethylene (PE), ionomer resin, transparent polypropylene (PP), fluorinated ethylene propylene (FEP), styrene methyl methacrylate (SMMA), styrene acrylonitrile resin (SAN), general purpose polystyrene (GPPS), or methyl methacrylate acrylonitrile butadiene styrene (MABS), or any combination thereof.

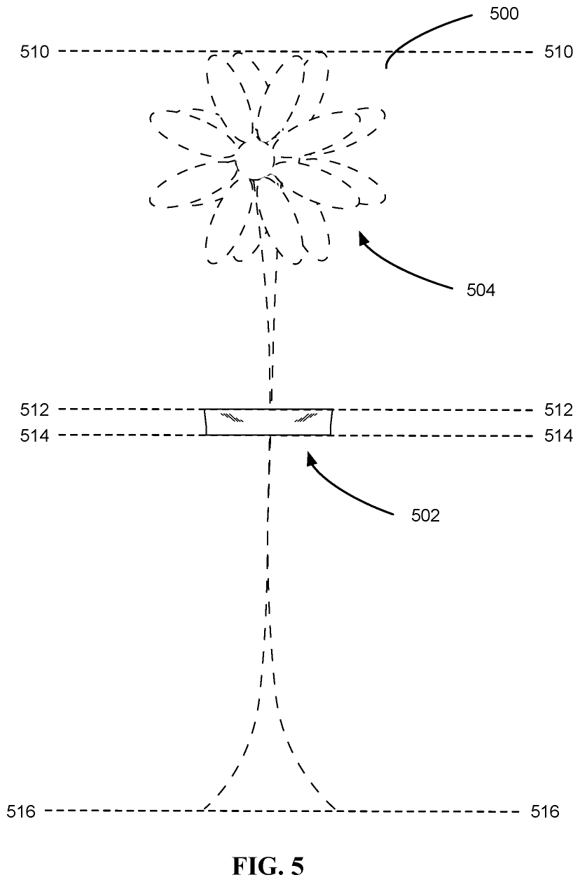

FIG. 5 illustrates a side view 500 of a design in accordance with an aspect or embodiment of the present invention. An object or article 502 with a side view that corresponds to the side view 200 is illustrated with holding a plurality of flowers 504.

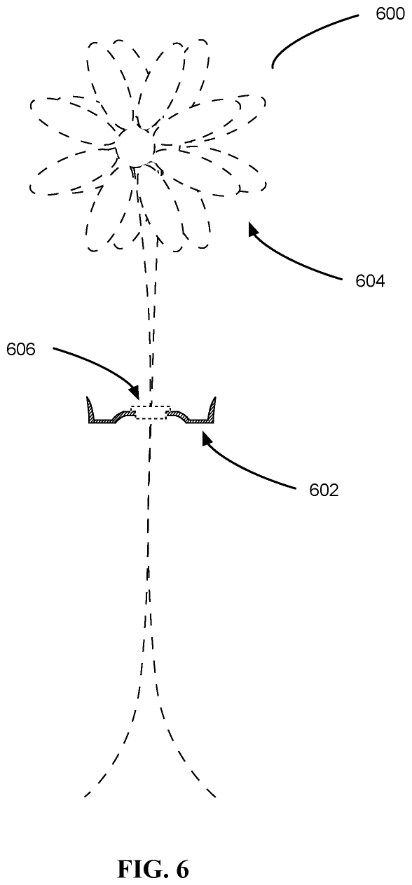

FIG. 6 illustrates a cross section view 600 of a design in accordance with an aspect or embodiment of the present invention. A cross section view 602 of an object or article with a top, side, bottom and sectional view that correspond respectively to the top view 100, side view 200, bottom view 300 and sectional view 400 is illustrated with holding a plurality of flowers 604 via contact, bonding, connection or coupling with a lengthwise section of the plurality of flowers 604. In one embodiment, such contact, bonding, connection, or coupling is achieved via an intermediary or a bridge. In another embodiment, such contact, bonding, connection or coupling is achieved via a means of attachment or coupling 606. In one embodiment, the means of attachment or coupling 606 may comprise a band, disc, plug, collar, ridge, ring, edge, wrap, shield or part that is a part of the plurality of flowers 604, such as one attached around a bouquet, or a single monolithic solid plastic section of a stem or trunk, from which a plurality of artificial flowers are extended upward and from which a plurality of artificial stems are extended downward with respect to the section of the stem or trunk. In one embodiment, such a means of attachment or coupling may specifically be made or built into the plurality of flowers 604 to fit in the inner opening of the object or article, and sit statically on top of the opening. In one embodiment, the means of attachment or coupling 606 may be affixed or attached to the inner opening of the object or article by adhesive material such as glue. In another embodiment, the means of attachment or coupling 606 may comprise adhesive material that bonds the object or article with the plurality of flowers 604. In one embodiment, the means of attachment or coupling 606 may comprise 100% adhesive material.

In one embodiment, the means of attachment or coupling 606 may comprise a band, disc, plug, collar, ridge, ring, edge, wrap, shield or part that is an add-on or an external part to the plurality of flowers 604. In one embodiment, such a means of attachment or coupling may specifically be made or built for adapting the plurality of flowers 604 to fit in the inner opening of the object or article, and sit statically on top of the opening. In one embodiment, the means of attachment or coupling 606 may be affixed or attached to the plurality of flowers 604 by adhesive material such as glue. In one embodiment, the means of attachment or coupling 606 may be affixed or attached to the inner opening of the object or article by adhesive material such as glue. In another embodiment, the means of attachment or coupling 606 may comprise adhesive material that bonds the object or article with the plurality of flowers 604. In yet another embodiment, the means of attachment or coupling 606 may comprise 100% adhesive material.

In one embodiment, the means of attachment or coupling 606 may comprise fabric, textile, and the like. In one embodiment, the means of attachment or coupling 606 may comprise or be made of semi-rigid material, such as semi-rigid synthetic-polymer, semi-rigid plastic plug, or semi-rigid nylon tube fitting, or any combination thereof. In another embodiment, the means of attachment or coupling 606 may comprise or be made of plastic, glass, crystal, or metal, or any combination thereof. In one embodiment, the means of attachment or coupling 606 may comprise or be made of transparent or translucent material. In one embodiment, the means of attachment or coupling 606 may comprise or be made of colored material. In one embodiment, the means of attachment or coupling 606 may comprise or be made of polycarbonate (PC), acrylic, polyethylene terephthalate (PET), amorphous copolyester (PETG), polyvinyl chloride (PVC), liquid silicone rubber (LSR), cyclic olefin copolymers (COC), polyethylene (PE), ionomer resin, transparent polypropylene (PP), fluorinated ethylene propylene (FEP), styrene methyl methacrylate (SMMA), styrene acrylonitrile resin (SAN), general purpose polystyrene (GPPS), or methyl methacrylate acrylonitrile butadiene styrene (MABS), or any combination thereof

In one embodiment, the means of attachment or coupling 606 may comprise a and, disc, plug, collar, ridge, ring, edge, wrap, shield or part that possesses or otherwise is equipped with a fastener for attachment to the opening of the object or article. For example, one or more sections at or around the opening of the object or article may comprise nylon piles or loops that can interlock with nylon hooks located on one or more surface sections of such a band, disc, plug, collar, ridge, ring, edge, wrap, shield or part.

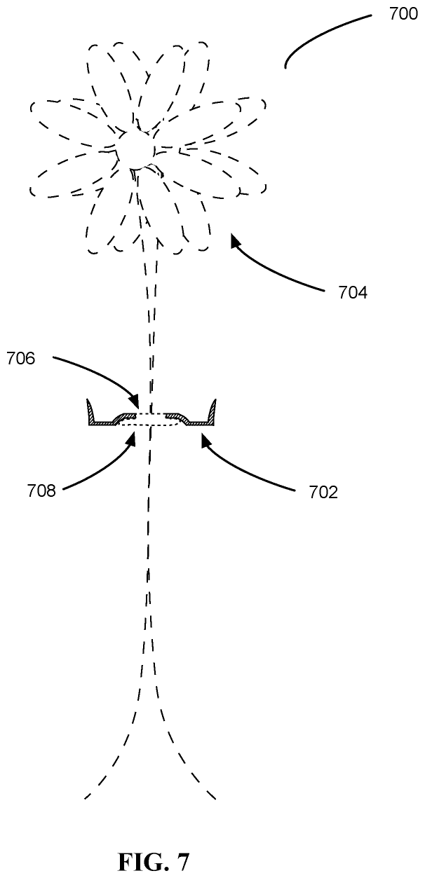

FIG. 7 illustrates another cross section view of a design in accordance with an aspect or embodiment of the present invention. A cross section view 702 of an object or article with a top, side, bottom and sectional view that correspond respectively to the top view 100, side view 200, bottom view 300 and sectional view 400 is illustrated with holding a plurality of flowers 704 via contact, bonding, connection, or coupling with a lengthwise section of the plurality of flowers 704. In one embodiment, such contact, bonding, connection, or coupling is achieved via an intermediary or a bridge. In another embodiment, such contact, bonding, connection or coupling is achieved via a means of attachment or coupling 706. In one embodiment, the means of attachment or coupling 706 may comprise a molding that fills at least partially the recess or space 708 formed at the lower part of the object or article, thereby binding or affixing the plurality of flowers, such as a bouquet, to the object or article. In one embodiment, the means of attachment or coupling 706 may comprise an adhesive molding and the plurality of flowers may comprise an artificial bouquet. In another embodiment, the means of attachment or coupling 706 may comprise adhesive material, and a band, disc, plug, collar, ridge, ring, edge, wrap, shield or part that is a part of the plurality of flowers 704. For example, the adhesive material such as glue may bind such a band, disc, plug, collar, ridge, ring, edge, wrap, shield or part to at least a part of the surface of one or more inner sides of the object or article, where the one or more inner sides form or otherwise surround the recess or space 708. In one embodiment, the means of attachment or coupling 706 may comprise adhesive material, as well as a band, disc, plug, collar, ridge, ring, edge, wrap, shield or part that is not a part of the plurality of flowers 704. For example, such a band, disc, plug, collar, ridge, ring, edge, wrap, shield or part may be attached to a lengthwise section of the one or more stems of the plurality of flowers 704 via adhesive material such as glue.

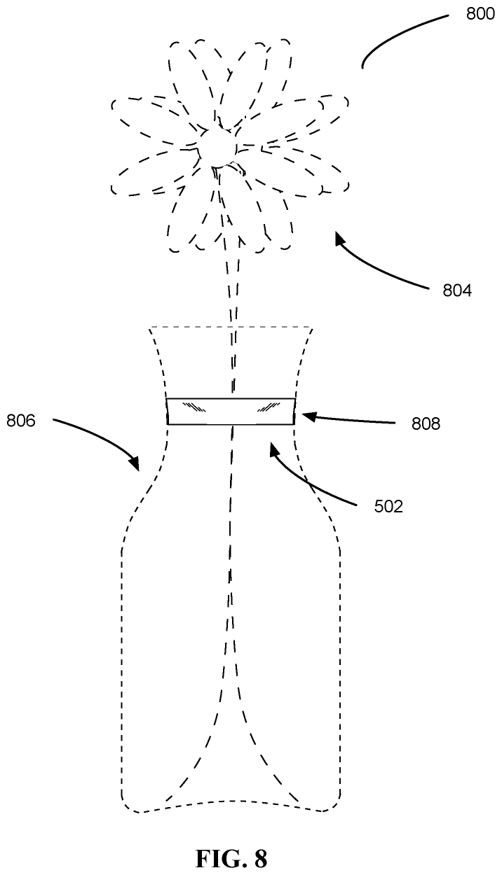

FIG. 8 illustrates a composite view 800 of a design in accordance with an aspect or embodiment of the present invention. The object or article 502 is illustrated with holding a plurality of flowers 804 in a container with a cross section view 806 of an inner surface of the container. In one embodiment, the exterior side of the object or article 502 curves inwards, matching approximately or sufficiently the curvature of a section 808 of the inner surface, where such matching enables the object or article 502 to hold in place while being inside the container, when the exterior side of the object or article 502 comes in contact with the inner surface at or around the section 808. In one embodiment, the curvature of the exterior side of the object or article 502 corresponds approximately or sufficiently to the curvature of the section 808 of the inner surface, thereby facilitating the object or article 502 to stay in place at the neck of the container when the exterior side of the object or article 502 comes in contact with the inner surface at or around the section 808. In one embodiment, the measured width or diameter of the object or article 502 may be larger than the measured width or diameter of the inner cross section space or plane of the neck of the bottle where the object or article 502 is to be situated at or near. In one embodiment, the object or article 502 comprises flexible or semi-rigid material which allows the object or article 502 to flex or bend. For example, one or more sections from among the exterior side(s) of the object or article 502 may flex or bend to fit the object or article 502 within the inner surface of the neck. In one embodiment, the bottom of the object or article 502 may additionally flex or bend to fit the object or article 502 within the inner surface of the neck. In one embodiment, the object or article 502 can flex or bend its exterior side(s) and/or bottom to fit the object or article 502 within the inner surface of the neck so to leave no gap or hole, thereby creating a sealed partition at the neck of the container. In one embodiment, such a partition prevents liquid substances below the neck from leaving the container when the container is placed sideways or upside down.

An article embodying at least one aspect of the present invention may comprise three sections. Specifically, the first section may comprise one or more sides and one or more widths, the one or more widths fitting within a neck of a container by having the one or more sides in contact with one or more sections of an inner surface of the neck, and the container comprising a mouth leading to the one or more sections of the inner surface of the neck. The second section may comprise one or more floral pieces, and at least one floral piece from among the one or more floral pieces extends above the opening of the mouth when the one or more sides associated with the first section are in contact with the one or more sections of the inner surface of the neck. The third section may comprise one or more stem pieces, and at least one stem piece from among the one or more stem pieces extends from below the neck when the one or more sides associated with the first section are in contact with the one or more sections of the inner surface of the neck. In one embodiment, such an article may comprise a side view resembling the side view 500 shown in FIG. 5, where the first section may correspond to a part or section similar to one delimited between or otherwise identified by the non-solid illustrative lines 512 and 514, the second section may correspond to a part or section similar to one delimited between or otherwise identified by the non-solid illustrative lines 510 and 512, and the third section may correspond to a part or section similar to one delimited between or otherwise identified by the non-solid illustrative lines 514 and 516. In one embodiment, such an article, when placed in a container, may comprise a side view resembling the composite view 800 shown in FIG. 8.

In one embodiment, a bouquet may comprise the second and third sections of such an article, and the first section comprises a band, disc, plug, collar, ridge, ring, edge, wrap, shield, or the like, having an inner opening at which a lengthwise portion of the bouquet, e.g., a section of its stem(s), may be placed. In one embodiment, such a lengthwise portion of the bouquet is placed at the inner opening partially. In one embodiment, the bouquet comprises artificial floral pieces, such as artificial flowers and stems, and such a lengthwise portion of the bouquet is made of plastic and/or fabric. The lengthwise portion is secured, fastened, coupled, affixed, or otherwise attached to the opening. In one embodiment, the lengthwise portion is bonded to the opening via adhesive material such as glue.

In one embodiment, a bouquet may comprise the second and third sections of such an article, as well as a band, disc, plug, collar, ridge, ring, edge, wrap, shield, or the like around a lengthwise portion of the bouquet. In one embodiment, such a lengthwise portion of the bouquet comprises one or more stems of the bouquet, where the lengthwise portion are situated between the second and third sections. In one embodiment, such a lengthwise portion of the bouquet is located beneath at one or more flowers, and the one or more floral pieces comprise the one or more flowers. In one embodiment, the first section comprises a receptacle, such as one similar to the opening 606 shown in FIG. 6, to which such a band, disc, plug, collar, ridge, ring, edge, wrap, shield, or the like around the lengthwise portion of the bouquet may be secured, fastened, coupled, affixed, or otherwise attached. In one embodiment, the lengthwise portion is bonded to the receptacle via adhesive material such as glue.

In one embodiment, at least a width or diameter of such a band, disc, plug, collar, ridge, ring, edge, wrap, shield, or the like is longer than at least a width or diameter of the receptacle, thereby enabling the first section to hold or support the bouquet by having the band, disc, plug, collar, ridge, ring, edge, wrap, shield, or the like sitting on top of the receptacle. In one embodiment, the three sections created by such placement of the bouquet constitute an article. In one embodiment, no adhesive material is used for such placement. In one embodiment, the combination of an object or article comprising the cross section view 602, the plurality of flowers 604, and the means of attachment or coupling 606 constitutes an article that comprises such three sections.

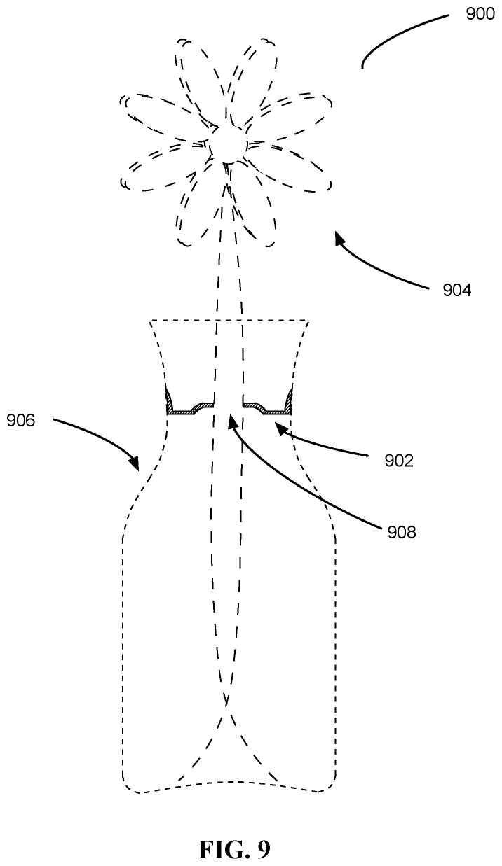

FIG. 9 illustrates another cross section view 900 of a design in accordance with an aspect or embodiment of the present invention. A cross section view 902 of an object or article with a top, side, bottom and sectional view that correspond respectively to the top view 100, side view 200, bottom view 300 and sectional view 400 is illustrated with supporting a plurality of flowers 904 in an upright or relatively vertical position in a container with a cross section view 906 of an inner surface of the container. In one embodiment, such support is achieved via contact between one or more sections of the inner opening 908 of the object or article and a lengthwise section of each of the one or more stems of the plurality of flowers 904. In one embodiment, an intermediary, a bridge or an additional means of attachment or coupling is not used between the inner opening 908 and the one or more stems of the plurality of flowers 904.

A process embodying at least one aspect of the present invention may comprise preparing an object, such as one resembling the object or article 502, with a top, side, bottom and sectional view that correspond respectively to the top view 100, side view 200, bottom view 300 and sectional view 400; affixing one or more floral pieces to the object, such as attaching via adhesive material or another means of connection or coupling a lengthwise section of each of the one or more stems of the one or more floral pieces to the inner opening of the object or article 502; and inserting the object or article 502 into a container via a mouth of the container, resulting in a side view similar to the side view 800, when the container is placed upright or in a vertically inclined position.

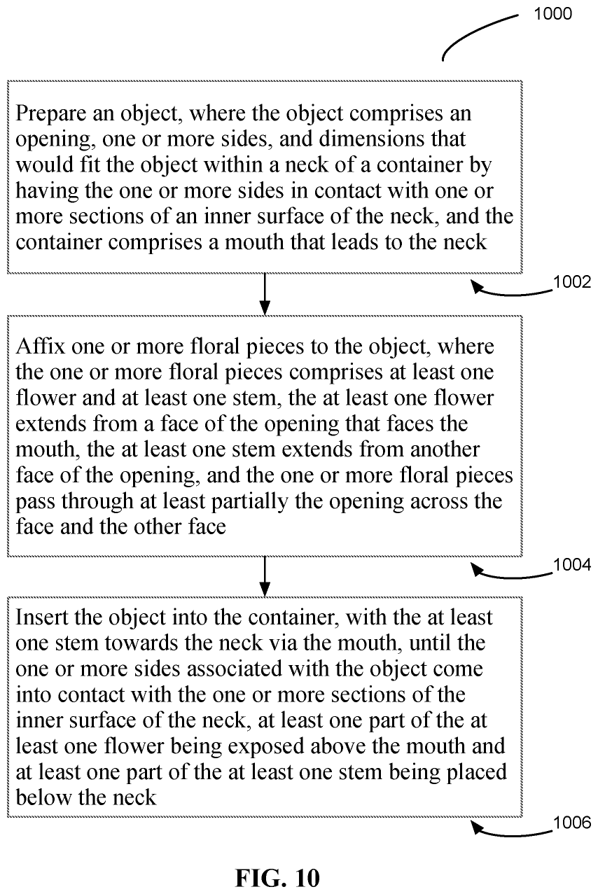

FIG. 10 illustrates an exemplary method or process 1000 for providing floral arrangement involving a container in accordance with an aspect or embodiment of the present invention. The exemplary method or process 1000 comprises preparing an object or a step 1002 thereof, where, for instance, the object comprises an opening, one or more sides, and dimensions that would fit the object within a neck of a container by having the one or more sides in contact with one or more sections of an inner surface of the neck, and the container comprises a mouth that leads to the neck; affixing one or more floral pieces to the object, or a step 1004 thereof, where, for instance, the one or more floral pieces comprises at least one flower and at least one stem, the at least one flower extends from a face of the opening that faces the mouth, the at least one stem extends from another face of the opening, and the one or more floral pieces pass through at least partially the opening across the face and the other face; and inserting the object into the container, or a step 1006 thereof, with the at least one stem towards the neck via the mouth, until the one or more sides associated with the object come into contact with the one or more sections of the inner surface of the neck, at least one part of the at least one flower being exposed above the mouth and at least one part of the at least one stem being placed below the neck.

In one embodiment, cross-section planes from the mouth of the container to the one or more sections of the inner surface of the neck comprise perimeters large enough for the object, with a face of the object's opening facing the mouth, to arrive at the one or more sections via the mouth, and one or more cross-section planes beyond the one or more sections comprise perimeters small enough for preventing the object from arriving beyond the one or more sections.

In one embodiment, the one or more floral pieces may comprise at least one artificial flower, and the one or more floral pieces may be affixed to the object by bonding at least a lengthwise section of the one or more floral pieces to the opening associated with the object.

In one embodiment, the one or more sides associated with the object may comprise one or more ridges, and the one or more sections of the inner surface comprise one or more grooves, where the one or more ridges fits for being received by the one or more grooves.

In one embodiment, at least one substance is placed in the container before the object is inserted into the container. In one embodiment, such a substance is in liquid form such as water or some colored liquid solution. In another embodiment, such a substance is in solid form such as one or more marbles. In one embodiment, the at least one substance forms a surface beneath the mouth of the container and at least a portion of the at least one part of the at least one stem of the one or more floral pieces is beneath the surface when the container stands upright.

In one embodiment, a band such as one comprising a bow is affixed on or near an outer surface of the neck of the container, where the outer surface is on the other side of the inner surface of the neck.

In one embodiment, at least one substance is placed in the container after the object is inserted into the container, and the object comprises one or more hollow spaces, through which the at least one substance is placed in the container. In one embodiment, a cover or a plug is placed on or into each of the one or more hollow spaces, thereby creating a cap or seal within the container. In one embodiment, the one or more sides associated with the object and the one or more sections of the inner surface are coupled via static friction. In one embodiment, a combination of such static coupling and such a cap or seal confines the at least one substance to the bottle, thereby preventing the at least one substance from leaving the container should the container is placed sideways or upside down.

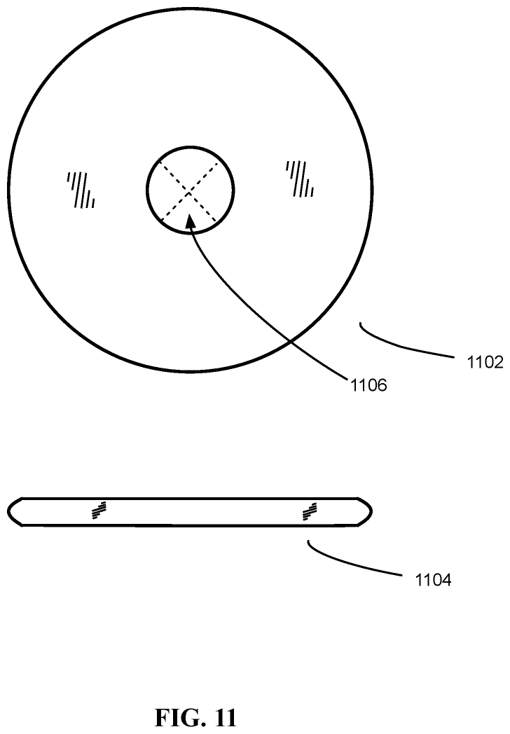

FIG. 11 illustrates a top view 1102 and a side view 1104 of a design in accordance with an aspect or an embodiment of the present invention. In one embodiment, an object or article similar in role or in function to the object or article 502 may comprise the top view 1102 and the side view 1104. It may comprise or be made of one or more materials that have been specified earlier. Such an object or article comprises a receptacle or an opening 1106, which serves a similar purpose as the inner opening 908 shown in FIG. 9. In one embodiment, such an object or article resembles a disc, where one or more floral pieces with one or more stems may be bound to the object or article via the opening 1106. In one embodiment, there is a color line around the exterior perimeter or circumference of such an object or article, where the color is different from that of the material that the object or article is made of, for example, a gold perimeter or circumference line on the object or article that is made of glass or crystal.

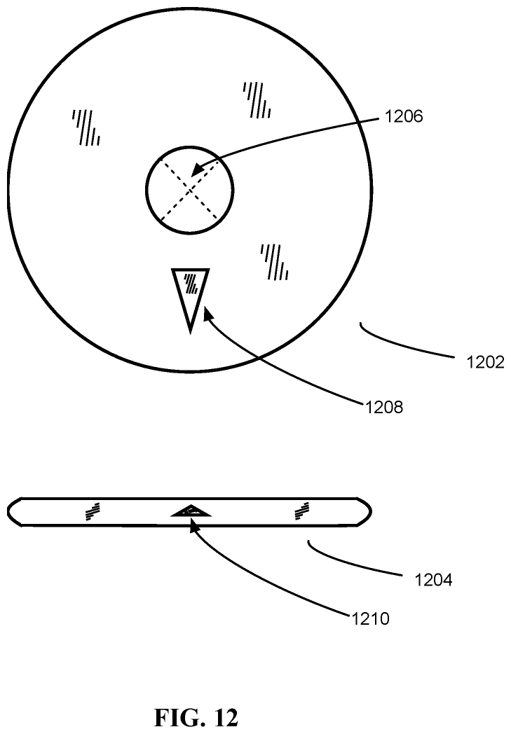

FIG. 12 illustrates a top view 1202 and a side view 1204 of a design in accordance with an aspect or an embodiment of the present invention. In one embodiment, an object or article similar in role or in function to the object or article 502 may comprise the top view 1202 and the side view 1204. It may comprise or be made of one or more materials that have been specified earlier. Such an object or article comprises a receptacle or an opening 1206, which serves a similar purpose as the inner opening 908 shown in FIG. 9. In one embodiment, such an object or article comprises an indication 1208 on the top view 1202 that points to, aligns with, or otherwise identifies where a floral arrangement should face. In one embodiment, such an object or article comprises an indication 1210 on the side view 1204 that aligns with or otherwise identifies how a floral arrangement should be oriented.

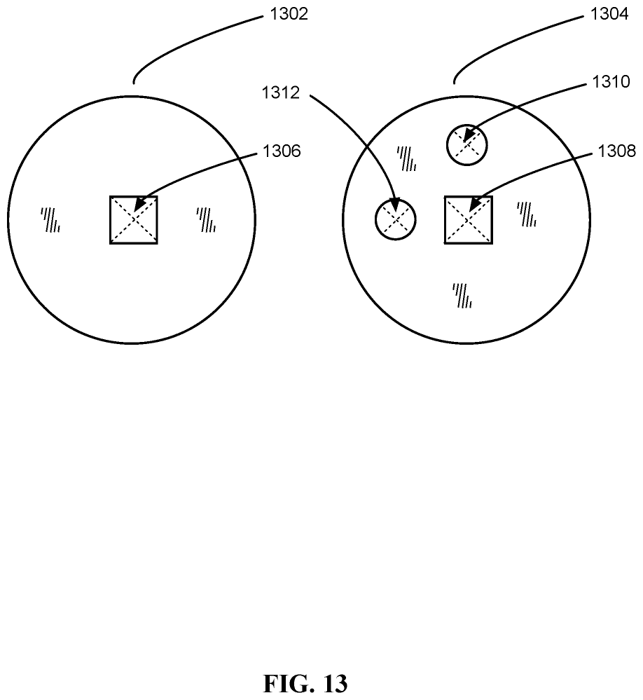

FIG. 13 illustrates top views 1302, 1304 of two designs in accordance with an aspect or an embodiment of the present invention. The top view 1302 reveals a receptacle or opening 1306 that is rectangular. In one embodiment, the outward shape of such a receptacle or opening can be in a shape of polygon. In one embodiment, the outward shape of such a receptacle or opening can have a different shape from the inward shape formed by the inner sides or surfaces of the receptacle and opening, such as a square outward shape and round inward shape.

The top view 1304 reveals a square receptacle or opening 1308, and two additional openings 1310, 1312. In one embodiment, an object or article similar in role or in function to the object or article 502 may comprise the top view 1304 and the side view 1204. In one embodiment, such an object or article is placed at a neck of a container, where liquid substance may be delivered to the container through one of the openings 1310, 1312, while the other opening allows the air from the container to escape. In one embodiment, such an object or article is sealed, for example by friction and/or adhesive material, at or around the neck of the container, and a plug, cap, or cover (not shown in FIG. 13) is applied to each of the openings 1310, 1312 to provide a seal or partition against the liquid substance in the bottle to escape from the bottle should the bottle is placed sideways or upside down.

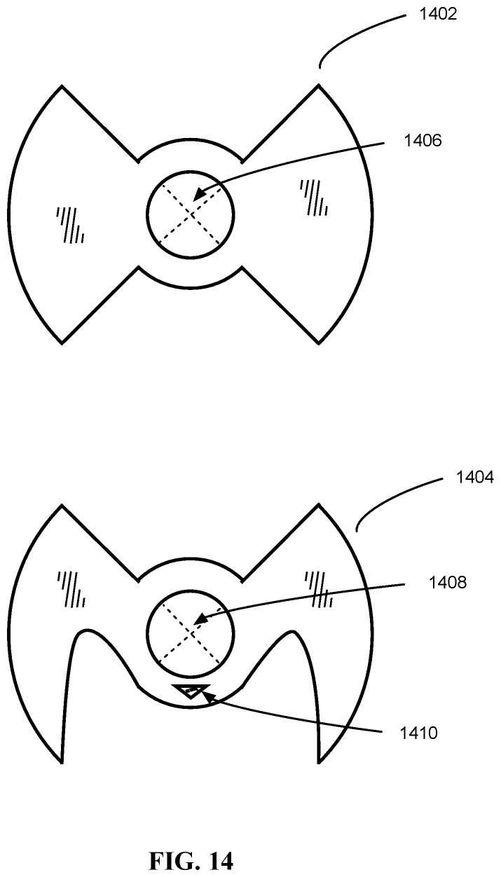

FIG. 14 illustrates top views 1402, 1404 of two designs in accordance with an aspect or an embodiment of the present invention. The top view 1402 reveals a receptacle or opening 1406, and an exterior perimeter or outline in shape of a polygon. In one embodiment, an object or article similar in role or in function to the object or article 502 may comprise the top view 1402. In one embodiment, such an object or article would have less contact with the neck of the container. One advantage of such design is that less of the object or article would be revealed or otherwise seen from outside the bottle when the bottle is made of glass, crystal, or some other transparent or translucent material.

The top view 1404 reveals a receptacle or opening 1408, an exterior perimeter or outline in a shape that comprises curve and straight lines, and an orientation indicator 1410 similar in purpose to indicators 1208, 1210 shown in FIG. 12. In one embodiment, an object or article similar in role or in function to the object or article 502 may comprise the top view 1404. In one embodiment, such an object or article would have less contact with the neck of the container. One advantage of such design is that less of the object or article will be revealed or otherwise seen from outside the bottle when the bottle is made of glass, crystal, or some other transparent or translucent material. In one embodiment, such an advantage is optimal when a presentational front of a floral arrangement is aligned with the orientation indicator 1410.

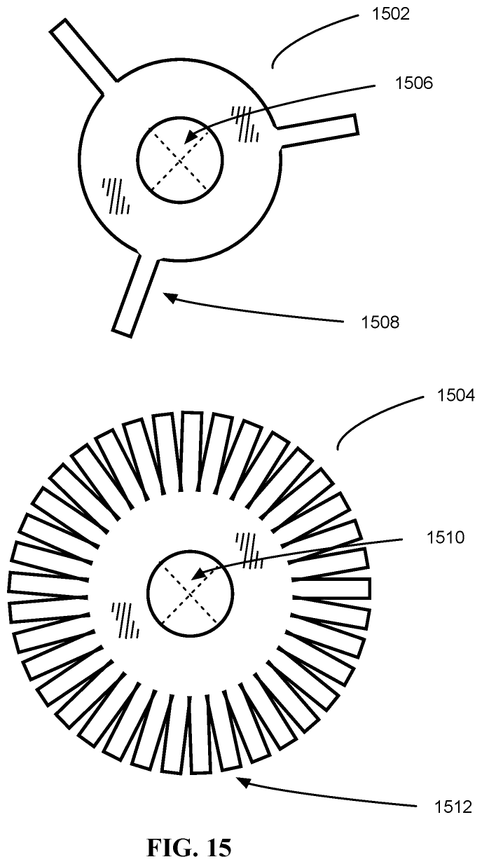

FIG. 15 illustrates top views 1502, 1504 of two designs in accordance with an aspect or an embodiment of the present invention. The top view 1502 reveals a receptacle or opening 1506 and an exterior perimeter or outline in a shape that comprises curve and straight lines. Such a shape reveals three pieces each resembling a rod or a spoke that radiates from the center, and a piece 1508 is one of the three pieces. In one embodiment, an object or article similar in role or in function to the object or article 502 may comprise the top view 1502. In one embodiment, such an object or article would fit into a bottle that comprises a mouth and a neck of a circular shape, where the neck comprises one or more sections of inner surface that provide support to the three pieces. In another embodiment, such an object or article would fit into a bottle that comprises a mouth and a neck of a compatible triangular shape.

The top view 1504 reveals a receptacle or opening 1510 and an exterior perimeter or outline in a shape that comprises predominately straight lines. Such a shape reveals a plurality of pieces each resembling a rod or a spoke that radiates from the center, and a piece 1512 is from among the plurality of pieces. In one embodiment, an object or article similar in role or in function to the object or article 502 may comprise the top view 1504. In one embodiment, such an object or article would fit into a bottle that comprises a neck of a shape that would allow the object or article to be placed at the neck, for example, through the mouth of the container or an opening at or near the neck such as a slot from a side (e.g., a back side) of the container, where the neck comprises one or more sections or regions of inner surface that can provide support to at least three pieces from among the plurality of pieces.

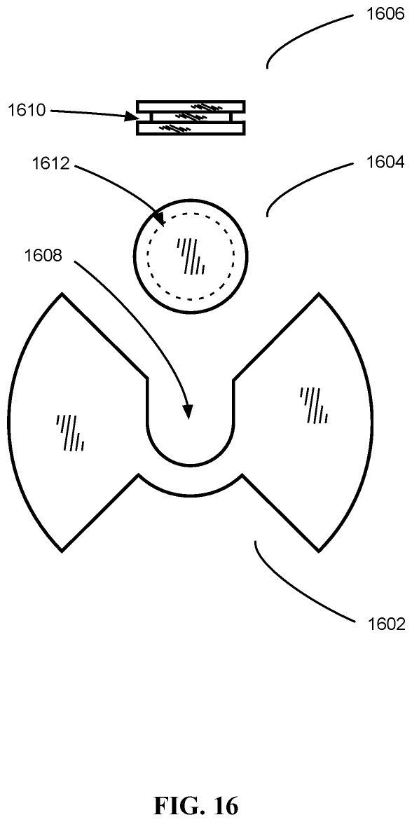

FIG. 16 illustrates top views 1602, 1604 and a side view 1606 in accordance with an aspect or an embodiment of the present invention. The top view 1602 reveals a receptacle or opening 1608 that is not completely enclosed. The top view 1604 reveals a part that may fit into the receptacle or opening 1608 via an inner groove 1610 identified by a dotted line 1612, and revealed by the side view 1606. In one embodiment, an object or article similar in role or in function to the object or article 502 may comprise the top view 1602. In one embodiment, one or more floral pieces such as the plurality of flowers 504 shown in FIG. 5 may comprise a section, such as a lengthwise part of or an add-on part to the stem(s) of the one or more floral pieces, the section having a side view similar in design or role to the side view 1610. In one embodiment, such a section is an add-on part attached to the stem(s) of the one or more floral pieces via adhesive material. In one embodiment, the one or more floral pieces may be attached or otherwise coupled to such an object or article through one or more inner grooves of this section that can receive one or more edges, ridges, or sides formed or outlined by the receptacle or opening 1608. In one embodiment, a collection of one or more floral pieces, such as a bouquet, comprises one or more stems, and a section of the one or more stems comprises one or more grooves or slots that are oriented perpendicular to the lengthwise section. The collection of one or more floral pieces is attached to an object or article comprising a receptacle or opening that resembles the receptacle or opening 1608, by having the one or more grooves or slots to receive the one or more edges, ridges, or sides formed or outlined by such a receptacle or opening.

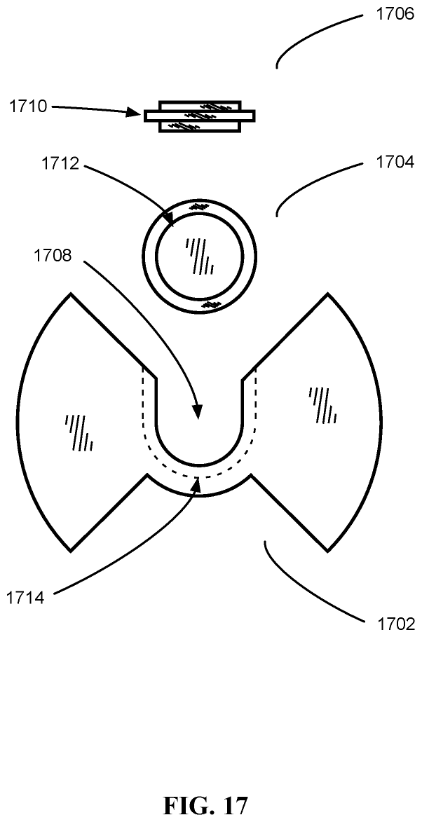

FIG. 17 illustrates top views 1702, 1704 and a side view 1706 in accordance with an aspect or an embodiment of the present invention. The top view 1702 reveals a receptacle or opening 1708 that is not completely enclosed. The top view 1704 reveals a part that may fit into the receptacle or opening 1708 via an edge, ridge, side or disc 1710 identified by a perimeter 1712 as seen on the top view 1704, and revealed by the side view 1706. The top view 1702 also reveals one or more grooves that may receive the edge, ridge, side or disc 1710, and such one or more grooves are identified by a dotted line 1714. In one embodiment, an object or article similar in role or in function to the object or article 502 may comprise the top view 1702. In one embodiment, one or more floral pieces such as the plurality of flowers 504 shown in FIG. 5 may comprise a section, such as a lengthwise part of or an add-on part to the stem(s) of the one or more floral pieces, the section having a side view similar in design or role to the side view 1710. In one embodiment, such a section is an add-on part attached to the stem(s) of the one or more floral pieces via adhesive material. In one embodiment, the one or more floral pieces may be attached or otherwise coupled to such an object or article through one or more edges, ridges, sides or discs of this section that the one or more grooves of the opening associated with the object or article can receive. In one embodiment, such coupling is similar in design or role to how the edge, ridge, side or disc 1710 can be attached to the one or more grooves identified by a dotted line 1714. In one embodiment, a collection of one or more floral pieces, such as a bouquet, comprises one or more stems, and a section of the one or more stems comprises a disc, or one or more edges, ridges or sides, that are oriented perpendicular to the lengthwise section. The collection of one or more floral pieces is attached to an object or article comprising a receptacle or opening that resembles the receptacle or opening 1708, by having the one or more grooves or slots embedded in such a receptacle or opening, to receive the disc, or the one or more edges, ridges or sides.

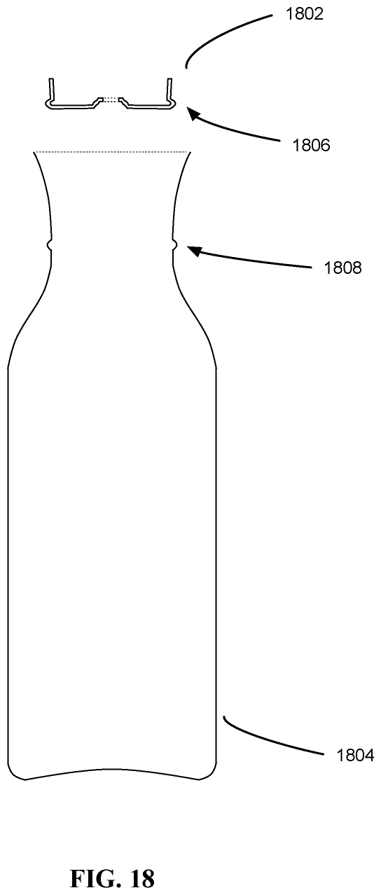

FIG. 18 illustrates a cross section view 1802 of an object or article and a cross section view 1804 of a container in accordance with an aspect or an embodiment of the present invention. In one embodiment, an object or article similar in role or in function to the object or article 502 may comprise the cross section view 1802. In one embodiment, a container with a cross section view similar to the cross section view 1804 may comprise one or more grooves around or at a horizontal section of its neck. Such an object or article may comprise a protruding exterior side or edge 1806 that fits at least partially into the one or more grooves. In one embodiment, the object or article may comprise or be made of semi-rigid material that allows the object or article to pass through the container's mouth towards the section of the neck despite the measured width or diameter of the protruding exterior side or edge 1806 may be larger than the various measured widths or diameters of the passage from the mouth to the neck, before reaching the section or part where the one or more grooves are located or situated.

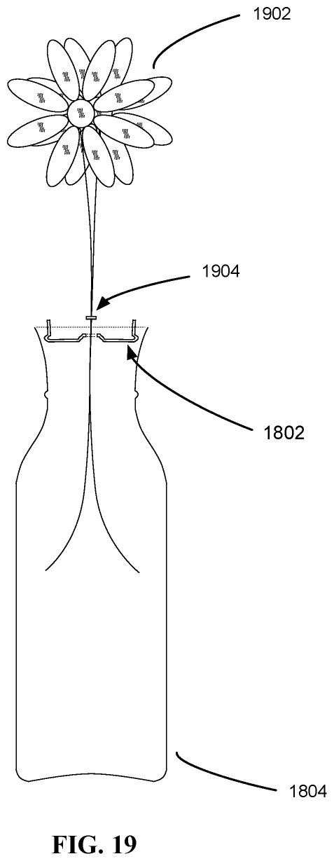

FIG. 19 illustrates the cross section views 1802, 1804 along with flowers 1902 and a part 1904, in accordance with an aspect or an embodiment of the present invention. The flowers 1092 comprises the part 1904 that may fit into the opening or receptacle of the object or article comprising the cross section view 1802.

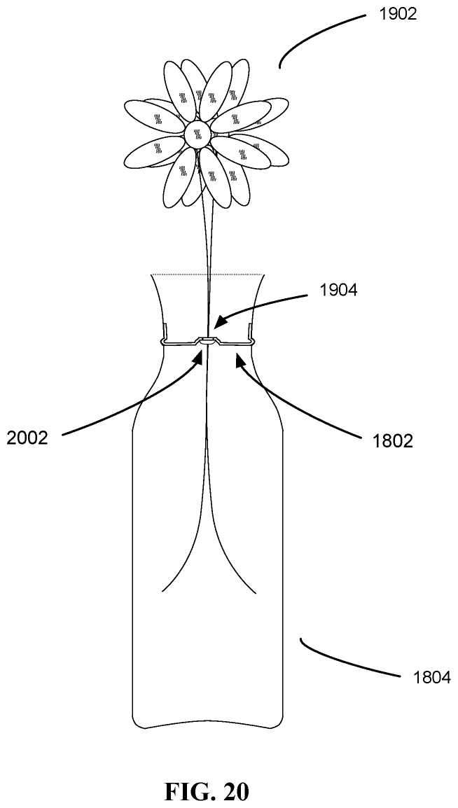

FIG. 20 illustrates the cross section views 1802, 1804, the flowers 1902 and the part 1904 along with a binding part or material 2002 shown, in accordance with an aspect or an embodiment of the present invention. In one embodiment, the binding part or material 2002 comprises a part that can be fully embedded in the recess area underneath the opening or receptacle of the object or article comprising the cross section view 1802. In one embodiment, the binding part or material 2002 comprises a part that can be partially embedded in the recess area underneath the opening or receptacle of the object or article comprising the cross section view 1802. In one embodiment, the part 2002 is attached via adhesive material to the part 1904 and the opening or receptacle. In one embodiment, the binding part or material 2002 comprises adhesive material. In another embodiment, the binding part or material 2002 comprises 100% adhesive material. In one embodiment, the adhesive material is cured or otherwise set in, and it is dry and not sticky to touch.

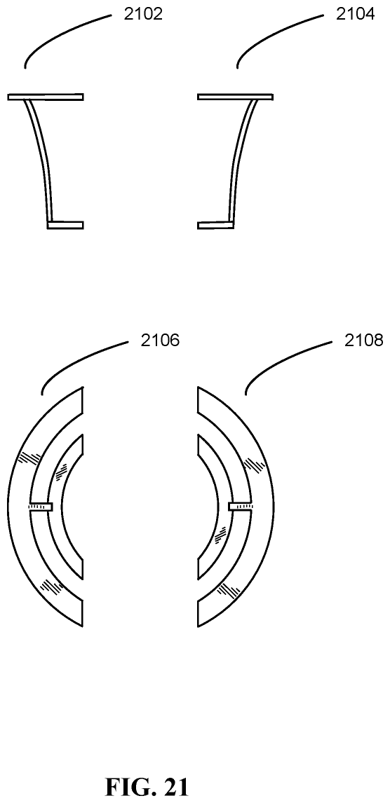

FIG. 21 illustrates cross section views 2102, 2104 and top views 2106, 2018 of a pair of tools in accordance with an aspect or an embodiment of the present invention. In one embodiment, a first tool that comprises a cross section view and a top view similar to the cross section view 2102 and the top view 2106 respectively may be used to help insert into a container an object or article such as the object or article 502 shown in FIG. 5. A second tool that comprises a cross section view and a top view similar to the cross section view 2104 and the top view 2108 respectively may be used to help insert into a container an object or article such as the object or article 502 shown in FIG. 5. In one embodiment, after placing the object or article into the container through the container's mouth, and placing the bottoms of the first and second tools against an opposite side on top of the object or article, a user may use his thumbs or fingers to apply pressure on the top of each of the first and second tools so to slide the object or article into its intended location at the neck of the container. In one embodiment, the first and second tools may comprise or be made of plastic. In another embodiment, the first and second tools may comprise or be made of metal. In one embodiment, the height of the first and second tools is approximately equal. In another embodiment, the vertical distance from the underside of the top to the underside of the bottom of the first tool corresponds to the vertical distance from the top of the container to the upper side of the top of the object or article when the object or article is placed at the intended location at the neck of the container. In one embodiment, the underside of each of the first and second tools touches the top or rim of the mouth of the container when the object or article having been pushed by the tools arrives at the intended location at the neck of the container.

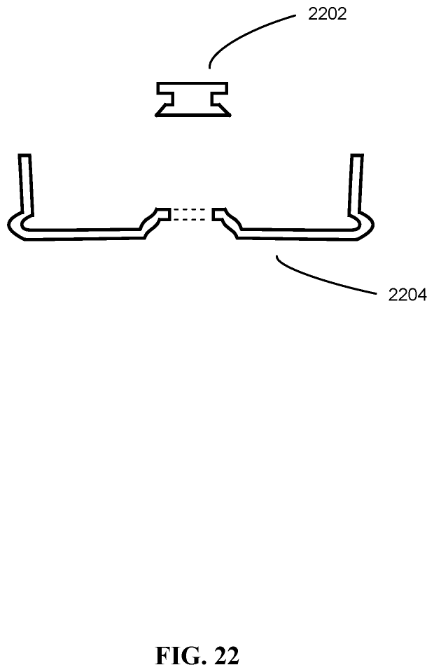

FIG. 22 illustrates a cross section view 2202 of a part or section and a cross section view 2204 of an object or article in accordance with an aspect or an embodiment of the present invention. The cross section view 2204 resembles the cross section view 602, and an object or article comprising a cross section similar to the cross section view 2204 may be coupled to one or more floral pieces without the need of adhesive when, for example, the one or more floral pieces comprise a section or part, such as a lengthwise part of, or an add-on part attached to, the stem(s) of the one or more floral pieces, the section or part having a cross section view similar in design or role to the cross section view 2202. In one embodiment, adhesive material is added to such coupling.

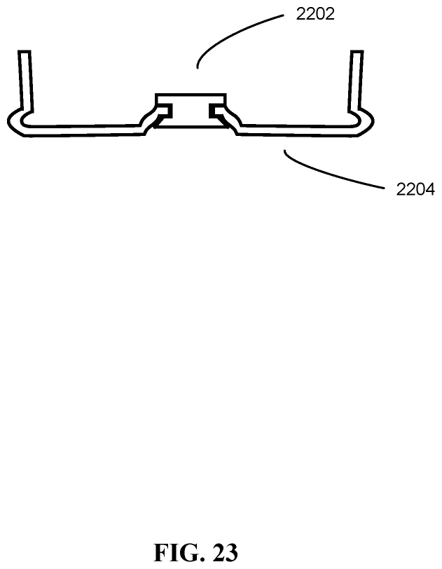

FIG. 23 illustrates a composite view based on the cross section view 2202 and the cross section view 2204 in accordance with an aspect or an embodiment of the present invention. Such a composite view demonstrates how an object or article comprising a cross section similar to the cross section view 2204 may be securely coupled with a section or part having a cross section view similar in design or role to the cross section view 2202. In one embodiment, no adhesive material is added to such coupling.

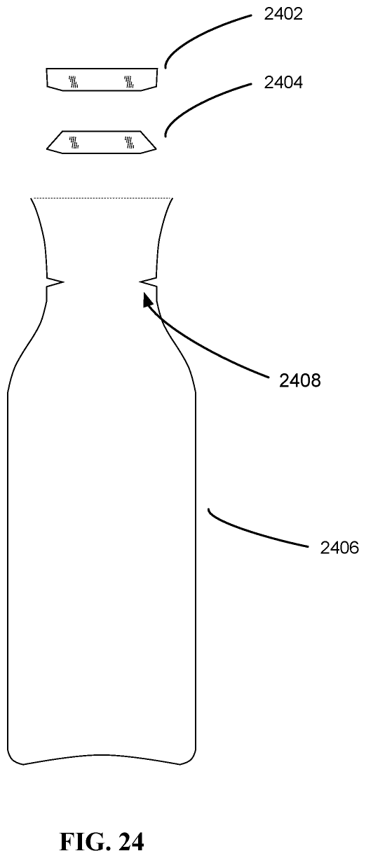

FIG. 24 illustrates two side views 2402, 2404 of two different objects or articles, and a cross section view 2406 of a container in accordance with an aspect or an embodiment of the present invention. In one embodiment, an object or article similar in role or in function to the object or article 502 may comprise the side view 2402. In one embodiment, a container with a cross section view similar to the cross section view 2406 may comprise one or more inward ridges, inward supports or inwardly protruding sides 2408 around or at a section of its neck. Such an object or article may be placed at the neck of the container by relying on the one or more inward ridges, inward supports or inwardly protruding sides 2408 as support. In one embodiment, the object or article may comprise one or more curved exterior sides that correspond to or approximate the curvature of one or more sections of an inner surface above the one or more inward ridges, inward supports or inwardly protruding sides 2408, such that the object or article may be situated or otherwise placed securely at the neck of the container. In one embodiment, such an object or article would not come off or away from the one or more inward ridges, inward supports or inwardly protruding sides 2408 when the container is placed sideways or upside down.

In one embodiment, an object or article similar in role or in function to the object or article 502 may comprise the side view 2404. In one embodiment, a container with a cross section view similar to the cross section view 2406 may comprise the one or more inward ridges, inward supports or inwardly protruding sides 2408 around or at a section of its neck. Such an object or article may be placed at the neck of the container by relying on the one or more inward ridges, inward supports or inwardly protruding sides 2408 as support. In one embodiment, the object or article may comprise one or more curved exterior sides that do not correspond to the curvature of one or more sections of an inner surface above the one or more inward ridges, inward supports or inwardly protruding sides 2408, such that the object or article may be situated or otherwise placed statically at the neck of the container, while being easy to remove from the container. In one embodiment, such an object or article would come off or away from the one or more inward ridges, inward supports or inwardly protruding sides 2408 when the container is placed sideways.

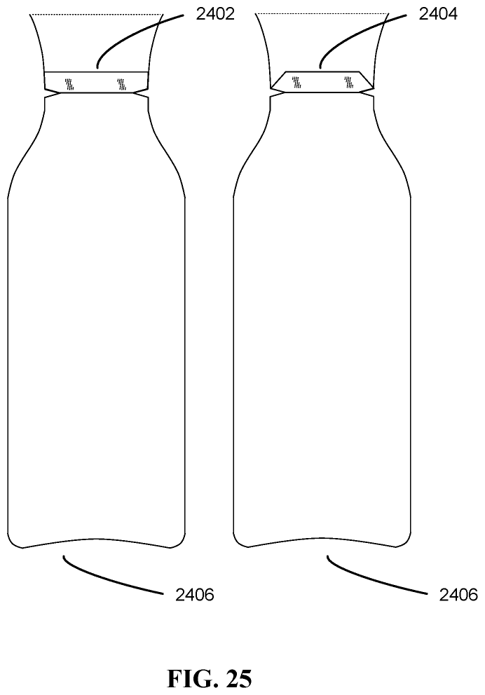

FIG. 25 illustrates the two side views 2402, 2404 as part of or in addition to the cross section view 2406, in accordance with an aspect or an embodiment of the present invention. The combination of the side view 2402 and the cross section 2406 as shown in FIG. 25 illustrates an exemplary steady state when an object or article comprising a side view similar to the side view 2402 is placed in a container comprising a cross section view similar to the cross section view 2406. In one embodiment, the container is made of transparent material such as glass or crystal.

The combination of the side view 2404 and the cross section 2406 as shown in FIG. 25 illustrates an exemplary steady state when an object or article comprising a side view similar to the side view 2404 is placed in a container comprising a cross section view similar to the cross section view 2406. In one embodiment, the container is made of opaque material such as porcelain or clay. In one embodiment, the container is a vase with a neck. In another embodiment, the container comprises a section between the mouth and the bottom, and the section is the narrowest from the mouth to the bottom of the container. In one embodiment, the container is a bottle comprising such a section. In another embodiment, such a section provides the support for the object or article.

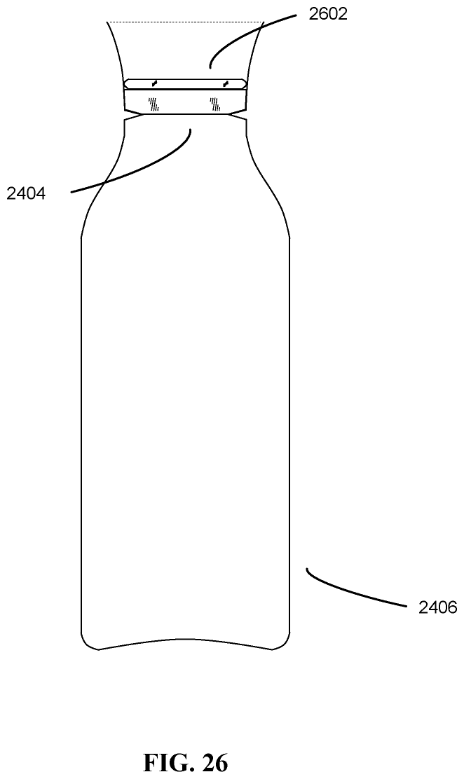

FIG. 26 illustrates the side view 2404, a side view 2602 of an object or article, and the cross section view 2406, in accordance with an aspect or an embodiment of the present invention. In one embodiment, an object or article similar in role or in function to the object or article 502 may comprise the side view 2602. Such an object or article may fit more loosely in comparison to how the object or article that comprises the side view 2404 fits the inner cross section or perimeter of the neck of the container. In one embodiment, the object or article that comprises the side view 2404 may provide the actual or main support for the object or article that comprises the side view 2602, where one or more floral pieces are bound to the latter object or article. This configuration enables a “plug and place” mechanism where the same container may be provisioned to accept some other bouquet equipped with an object or article at its stem that would not find sufficient direct support from the neck. Rather, the same object or article that comprises the side view 2404 would provide the support to the object or article that comprises the side view 2602. In one embodiment, none of the outer or exterior side of the object or article that comprises the side view 2602 needs to touch the inner surface of the container, and is supported by the object or article that comprises the side view 2404, where the bouquet is bound directly to the object or article that comprises the side view 2602.

In addition to the specific aspects, implementations, and embodiments explicitly set forth herein, other aspects, implementations, and embodiments will be apparent to those skilled in the art from consideration of the specification disclosed herein. It is intended that the specification and illustrated aspects, implementations, and embodiments be considered as examples only. For instance, while embodiments illustrate, among others, a band, disc, plug, collar, ridge, ring, edge, wrap or shield as means of attachment or coupling, it does not exclude other mechanisms or means of attachment, coupling or connection. In addition, while embodiments illustrate or discuss containers mostly with round perimeters of interior surfaces, it does not exclude containers with different shapes or forms, because one of ordinary skill in the art would be able to provide floral arrangements involving these containers based on the disclosure herein. For example, for a container with a square mouth and neck, an object or article similar to the object or article 502 in function may comprise exterior sides that resemble square in shape that matches or otherwise corresponds to the neck of the container, while having the same or a similar opening as the opening 908. Furthermore, an article, a component, a part or an object may combine or otherwise comprise different features that might have been attributed separately herein to different articles, components, parts or objects. For example, the object or article 502 may be adapted with the openings 1310, 1312 to arrive at a new object or article. Moreover, the present invention or an embodiment of the invention may comprise a plurality of inventive aspects, where one aspect alone or a subset from among them may be sufficient to provide meaningful improvements over the applicable art. Thus, although the invention has been described with respect to specific aspects, implementations, and embodiments, it will be appreciated that the invention is intended to cover all modifications and equivalents within the scope of the following claims.

What is claimed:

1. A method for providing floral arrangement involving a container, comprising:
preparing an object, wherein the object comprises an opening and one or more sides, the object comprising dimensions that fit the object within a neck of the container by having the one or more sides in contact with one or more sections of an inner surface of the neck, the container comprising a mouth leading to the one or more sections of the inner surface of the neck, cross-section planes from the mouth to the one or more sections comprising perimeters large enough for the object, with a face of the opening facing the mouth, to arrive at the one or more sections via the mouth, and one or more cross-section planes beyond the one or more sections comprising perimeters small enough for preventing the object from arriving beyond the one or more sections;
affixing one or more floral pieces to the object, wherein the one or more floral pieces comprises at least one flower and at least one stem, the at least one flower extends from the face of the opening associated with the object, the at least one stem extends from another face of the opening associated with the object, and the one or more floral pieces pass through at least partially the opening across the face and the other face; and
inserting the object into the container, with the at least one stem towards the neck via the mouth, until the one or more sides associated with the object come into contact with the one or more sections of the inner surface of the neck, at least one part of the at least one flower being exposed above the mouth and at least one part of the at least one stem being placed below the neck.

2. The method of claim 1, further comprising:
wherein the one or more floral pieces comprise at least one artificial flower; and
wherein affixing the one or more floral pieces to the object comprises bonding at least a lengthwise section of the one or more floral pieces to the opening associated with the object.

3. The method of claim 1, further comprising:
wherein the object comprises semi-rigid material;
wherein the one or more sides associated with the object comprise one or more ridges;
wherein the one or more sections of the inner surface comprise one or more grooves; and
wherein the one or more ridges fits for being received by the one or more grooves.

4. The method of claim 1, further comprising:
placing at least one substance in the container before the object is inserted into the container, wherein the at least one substance forms a surface beneath the mouth and at least a portion of the at least one part of the at least one stem is beneath the surface when the container stands upright.

5. The method of claim 1, further comprising:
placing at least one substance in the container after the object is inserted into the container; and
wherein the object comprises one or more hollow spaces, through which the at least one substance is placed in the container.

6. The method of claim 4, further comprising:
affixing a band on or near an outer surface of the neck, wherein the outer surface is on the other side of the inner surface of the neck.

7. The method of claim 5, further comprising:
placing a cover on or a plug into each of the one or more hollow spaces;
wherein the one or more sides associated with the object and the one or more sections of the inner surface are coupled via static friction; and
wherein the at least one substance is confined to the bottle if the container is held sideways or upside down.

8. An article for being placed in a container, the article comprising:
a first section, wherein the first section comprises one or more sides and one or more widths, the one or more widths fit within a neck of the container by having the one or more sides in contact with one or more sections of an inner surface of the neck, and the container comprises a mouth leading to the one or more sections of the inner surface of the neck;
a second section, wherein the second section comprises one or more floral pieces, and at least one floral piece from among the one or more floral pieces extends above the opening of the mouth when the one or more sides associated with the first section are in contact with the one or more sections of the inner surface; and
a third section, wherein the third section comprises one or more stem pieces, and at least one stem piece from among the one or more stem pieces extends below the neck when the one or more sides associated with the first section are in contact with the one or more sections of the inner surface.

9. The article of claim 8, further comprising:
the second section and the third section constitute a bouquet; and
the first section comprises an opening, wherein at least one lengthwise portion of the bouquet is situated in the opening at least partially.

10. The article of claim 9, further comprising:
wherein at least one floral piece from among the one or more floral pieces comprises an artificial flower;
wherein at least one stem piece from among the one or more stem pieces comprises an artificial stem; and
the bouquet and the opening are bonded by adhesive substance.

11. The article of claim 9, further comprising:
wherein the bouquet comprises a collar, wherein the collar is located beneath the one or more floral pieces; and
wherein the opening associated with the first section is coupled with the collar associated with the bouquet.

12. The article of claim 11, further comprising:
wherein the collar is placed on top of a face of the opening facing the mouth; and
wherein at least one width associated with the collar is longer than at least one width or diameter associated with the opening.

13. The article of claim 11, further comprising:
wherein the collar comprises one or more sides, and at least one side from among the one or more sides associated with the collar comprises one or more grooves or slots; and
wherein the opening comprises one or more edges or ridges, and the one or more edges or ridges fit into the one or more grooves or slots.

14. The article of claim 11, further comprising:
wherein the collar comprises one or more sides, and at least one side from among the one or more sides associated with the collar comprises one or more edges or ridges; and
wherein the opening comprises one or more grooves or slots, and the one or more edges or ridges fit into the one or more grooves or slots.

15. An apparatus comprising:
a container;
one or more floral pieces, wherein the one or more floral pieces comprise at least one flower and at least one stem;
an object, wherein the object comprises a receptacle and one or more sides, the object fits within an inner perimeter of a neck of the container through contact between the one or more sides of the object and one or more sections of the inner perimeter of the neck, and at least one lengthwise section associated with the one or more floral pieces fits into the receptacle; and
wherein the at least one flower extends away from the receptacle towards the top of the container, and the at least one stem extends away from the receptacle towards the bottom of the container.

16. The apparatus of claim 15, further comprising:
wherein the at least one flower comprises an artificial flower, and the at least one stem comprises an artificial stem; and
wherein the at least one lengthwise section associated with the one or more floral pieces is attached to the receptacle via an adhesive substance.

17. The apparatus of claim 15, wherein the receptacle holds the at least one lengthwise section in place by physical contact or static friction, independently of adhesive substance.

18. The apparatus of claim 15, further comprising:
a band, wherein the band affixes on or near an outer surface of the neck, wherein the outer surface is on the other side of the inner surface of the neck.

19. The apparatus of claim 15, further comprising:
wherein the one or more floral pieces comprise a collar, wherein the collar is located beneath the at least one flower; and
wherein the object is coupled to the one or more floral pieces via coupling between the receptacle and the collar.

20. The apparatus of claim 15, further comprising:
wherein the one or more sides of the object comprise one or more ridges or edges;
wherein the container comprises one or more grooves at an inner part of the neck, the inner part being at or near the inner perimeter of the neck;
wherein the object comprises semi-rigid material; and
wherein the one or more ridges or edges fit for being received by the one or more grooves.
